(19) United States
(12) Patent Application Publication
(10) Pub. No.: US 2014/0086703 A1
(43) Pub. Date: Mar. 27, 2014

(54) Self-Retaining Fastener

(71) Applicant: Friedrich THOMMES, Poolesville, MD (US)

(72) Inventor: Friedrich THOMMES, Poolesville, MD (US)

(21) Appl. No.: 14/038,282

(22) Filed: Sep. 26, 2013

Related U.S. Application Data
(60) Provisional application No. 61/706,031, filed on Sep. 26, 2012.
(60) Provisional application No. 61/715,150, filed on Oct. 17, 2012.

(51) Int. Cl. F16B 39/24

(52) U.S. Cl. CPC F16B 39/24
USPC 411/247

(57) ABSTRACT

A self-retaining fastener is designed to persistently secure a load between a nut and a bolt. The bolt has a bolt head, a bolt shaft, and a male threaded portion positioned along the bolt shaft to which a female threaded portion of the nut is secured. A retention spring is pressed against the nut and coiled around the bolt shaft when the nut is secured to the bolt. A first end of the retention spring is compressed against the nut opposite the load, while a second end of the retention spring is attached to a receiving volume of the bolt. The retention spring secures both the nut and load independent of the position the nut takes along the male threaded portion of the bolt. A bolt spring and a nut spring may also be used to provide increased contact area between bolt and load and between nut and load respectively.

The current application claims a priority to the U.S. Provisional Patent application Ser. No. 61/706,031 filed on Sep. 26, 2012 and the U.S. Provisional Patent application Ser. No. 61/715,150 filed on Oct. 17, 2012.

### FIELD OF THE INVENTION

The present invention relates generally to a fastener. More specifically, the present invention is a load bearing fastener that will not loosen under vibration, thermal, or pressure stress.

### BACKGROUND OF THE INVENTION

It is the nature of threaded fasteners to loosen under vibration as well as under thermal and pressure stresses. The loosening is often due to the failing clamping power of the nut. This can be due to uneven or un-matching contact surfaces or due to the inherent weakening of the original torque placed on the nut. Self-retaining fasteners that are currently in use often involve parts that are difficult to manufacture and do not allow for easy maintenance as many components are located internally.

Therefore it is the object of the present invention to provide a self-retaining fastener that can be easily and cheaply manufactured. The self-retaining fastener also features components that are all accessible to a user, which allows for the user to easily check that all components are properly functioning. The self-retaining fastener can be used to secure a load persistently without the need for the re-tightening of any components. The self-retaining fastener has a bolt and a nut used to secure a desired load. A retention spring provides balancing torque to the nut, while a bolt spring and nut spring provide more contact area between bolt and load and between nut and load, respectively. A first end of the retention spring is attached to the side of the nut opposite the load, while a second end of the retention spring is attached to a receiving volume of the bolt. The retention spring secures both nut and load independent of the position the nut takes up on the threaded portion of the bolt.

### BRIEF DESCRIPTION OF THE DRAWINGS

FIG. 1 is a front view of the bolt spring pressed against the bolt, with the bolt having a circular receiving volume.

FIG. 2 is a front view of the retention spring pressed against the nut.

FIG. 3 is a front view of the bolt having a partially threaded bolt shaft and an oval shaped receiving volume.

FIG. 4 is a front view of the retention spring having a straightened second end being positioned through the receiving volume in the bolt shaft.

FIG. 5 is a front sectional view of the retention spring having a straightened second end being positioned through the receiving volume in the bolt shaft.

FIG. 6 is a front view of the retention spring being attached to the bolt shaft via a lock pin.

FIG. 7 is a front view of the bolt, bolt spring, nut, retention spring, and nut spring assembly securing a load.

FIG. 8 is a front view of the bolt, bolt spring, nut and nut spring assembly securing a load.

FIG. 9 is a perspective view of the bolt having an encircling receiving volume for attaching the clamp of a retention spring.

FIG. 10 is a perspective view of the retention spring having a single piece clamp and being attached to the nut.

FIG. 11 is a front view of the retention spring being attached to the bolt shaft via the single piece clamp positioned within the circular receiving volume.

FIG. 12 is a front view of the retention spring being attached to the bolt shaft via a two piece clamp positioned around the male threaded portion.

FIG. 13 is a perspective view of the two piece clamp being open and having a threaded first and second claw.

FIG. 14 is a perspective view of the two piece clamp being open and having a moldable insert attached to the first and second claw.

FIG. 15 is a perspective view of the cap and decompressed cap spring.

FIG. 16 is a perspective of the cap and compressed cap spring with the nut being positioned within the cap.

FIG. 17 is a front view of the bolt and retention spring securing a threaded load without a nut.

FIG. 18 is a front sectional view of the bolt and bolt spring securing a threaded load having a load spring.

### DETAIL DESCRIPTIONS OF THE INVENTION

All illustrations of the drawings are for the purpose of describing selected versions of the present invention and are not intended to limit the scope of the present invention.

The present invention is a self-retaining fastener. The self-retaining fastener can be used a repeated number of times for any length of time. In the preferred embodiment of the present invention all components of the self-retaining fastener are made from a high-grade steel, however, it is possible that they be made from any number of other materials. It is also possible that different components be made of different materials. In instances of use where thermal conditions are a factor, it is to be known that the same material should be used for all components of the self-retaining fastener (ideally said material being hardened steel).

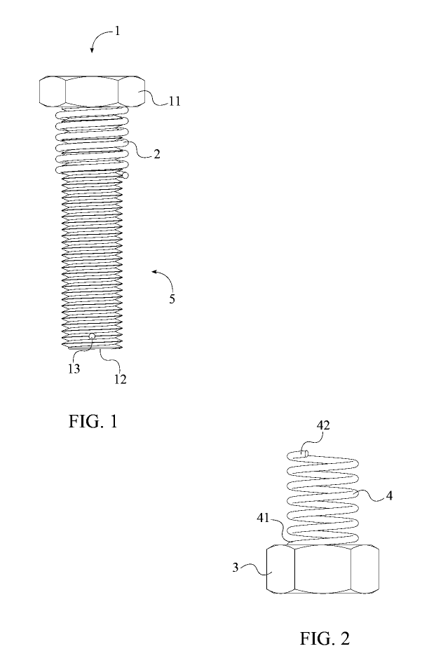

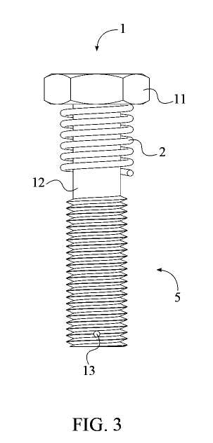

In reference to FIG. 1-2, the self-retaining fastener comprises a bolt 1, a nut 3 and a retention spring 4. The self-retaining fastener is designed to persistently secure a load between the nut 3 and bolt 1 by balancing the counter-torque in the tightened nut 3. The retention spring 4 is pressed against the nut 3 opposite the load and provides balancing torque to the nut 3 when the nut 3 is secured to the bolt 1. The self-retaining fastener may also comprise a bolt spring 2 and a nut spring 7. The bolt spring 2 provides a larger contact area between the bolt 1 and load, while the nut spring 7 provides a larger contact area between the nut 3 and load.

The bolt 1 comprises a bolt head 11, a bolt shaft 12 and a male threaded portion 5. The bolt shaft 12 is concentrically connected to the bolt head 11, while the male threaded portion 5 is positioned along the bolt shaft 12. The male threaded portion 5 may encompass the entirety of the bolt shaft 12 or only a section of the bolt shaft 12. The nut 3 comprises a female threaded portion 6, which is positioned through the center of the nut 3. The male threaded portion 5 of the bolt 1 engages the female threaded portion 6 of the nut 3, allowing the nut 3 to be securely attached to and positioned along the bolt shaft 12. In some embodiments of the present invention, only the nut 3 or the bolt 1 is used if the male threaded portion 5 or the female threaded portion 6 is positioned on an object other than the bolt 1 or nut 3. For example, the female threaded portion 6 may be positioned within the fastener hole of an engine block, wherein the portion of the engine block having the female threaded portion 6 functions as the nut 3.

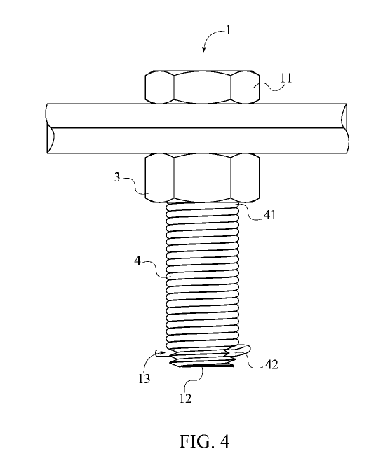

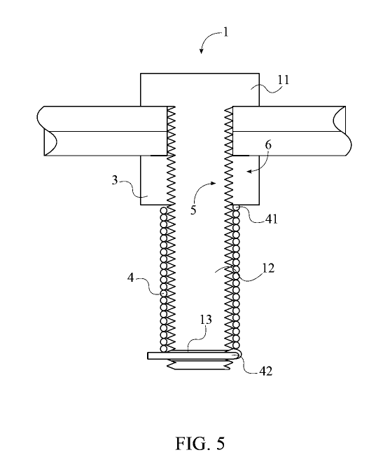

In reference to FIG. 4-5, the bolt head 11 secures one side of the load, while the nut 3 and the retention spring 4 secure the opposite side of the load. The retention spring 4 is pressed against the side of the nut 3 opposite of the load. The retention spring 4 is coiled such that the inner diameter of the coiled retention spring 4 is slightly larger than the outer diameter of the male threaded portion 5. A first end 41 and a second end 42 of the retention spring 4 are positioned opposite of each other along the retention spring 4. The first end 41 of the retention spring 4 is pressed against the nut 3, while the second end 42 of the retention spring 4 is straightened perpendicular to the length of the bolt shaft 12. The bolt 1 further comprises a receiving volume 13 that laterally traverses into the bolt shaft 12 and is positioned along the bolt shaft 12 opposite the bolt head 11. The receiving volume 13 can be either cut through the entire bolt shaft 12 or be cut only partially into the bolt shaft 12. The receiving volume 13 can be any shaped aperture in the bolt shaft 12 and can be of any size.

In further reference to FIG. 4-5, the nut 3 is tightened onto the male threaded portion 5 of the bolt shaft 12 until the nut 3 is in contact with the load, such that the nut 3 is positioned in between the bolt head 11 and the receiving volume 13 along the bolt shaft 12. Once the nut 3 has been positioned, the retention spring 4 can then be compressed and the second end 42 of the retention spring 4 is positioned into the receiving volume 13 in the bolt shaft 12. In this way, the retention spring 4 is secured in place to the bolt shaft 12. It is then a function of the retention spring 4 to provide balancing torque to the nut 3 allowing the nut 3 to retain its position along the male threaded portion 5 of the bolt shaft 12. The retention spring 4 secures both the nut 3 and load independent of the position the nut 3 takes along the male threaded portion 5 of the bolt 1. It is possible for the retention spring 4 to be permanently attached, removably attached, or not at all attached to the nut 3.

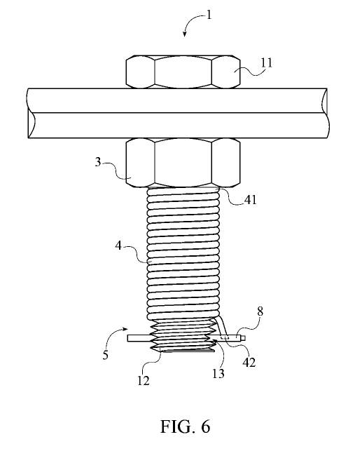

In an alternative embodiment of the present invention, the self-retaining fastener further comprises a lock pin 8, as shown in FIG. 6. The lock pin 8 is positioned into the receiving volume 13 in the bolt shaft 12 in place of the second end 42 of the retention spring 4. The second end 42 of the retention spring 4 is then positioned into the top of the lock pin 8. The second end 42 rests within a notch in the lock pin 8 and in this way, the retention spring 4 is secured in place to the bolt shaft 12. The lock pin 8 may also allow for other sections of the retention spring 4 to be attached to the lock pin 8. For example, the lock pin 8 may have an aperture in which a spring loaded clamp is positioned. The spring loaded clamp can be activated in order to allow passage of the retention spring 4 through the aperture. When the spring loaded clamp is released, it will act to close the aperture. In this way, a portion of the retention spring 4 can be threaded through the aperture and then clamped in place at the desired length. Additionally, this allows the user to determine the amount of compression in the retention spring 4 by the length of the retention spring 4 that is threaded through the aperture.

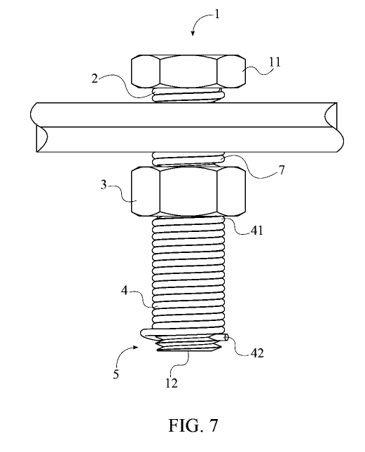

In reference to FIG. 7, the bolt spring 2 and/or the nut spring 7 may also be used in conjunction with the retention spring 4. When utilized, the bolt spring 2 is positioned in between the load and the bolt head 11, while the nut spring 7 is positioned in between the load and the side of the nut 3 opposite the retention spring 4. The bolt 1 and bolt spring 2 secure one side of the load, while the nut 3, nut spring 7, and retention spring 4 secure the opposite side of the load. The bolt spring 2 is coiled such that the inner diameter of the coiled bolt spring 2 is slightly larger than the outer diameter of the male threaded portion 5 of the bolt 1, yet smaller than the width of the nut 3. The bolt spring 2 is coiled around the bolt shaft 12 and is adjacently pressed against the underside of the bolt head 11. With the bolt spring 2 attached, the bolt shaft 12 is inserted through the load that is to be held together. In turn, the bolt spring 2 is compressed between the bolt head 11 and the load. The nut spring 7 is adjacently pressed against the nut 3 opposite the retention spring 4, and is coiled around the bolt shaft 12 when the nut 3 is attached to the bolt 1. Similar to the bolt spring 2 and the retention spring 4, the nut spring 7 is coiled in such a manner that the inner diameter of the coiled nut spring 7 is slightly larger than the outer diameter of the male threaded portion 5.

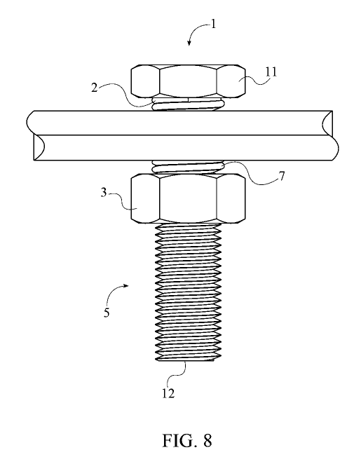

In further reference to FIG. 7, the nut 3 is threaded onto the male threaded portion 5 of the bolt shaft 12 with the nut spring 7 facing the load. As the nut 3 is continually threaded onto the male threaded portion 5 of the bolt shaft 12, the nut spring 7 is compressed between the nut 3 and the load. Loosening of the nut 3 on the bolt shaft 12 acts to decompress both the bolt spring 2 and the nut spring 7. When the nut 3 is tightened and both the bolt spring 2 and nut spring 7 are compressed, a larger contact area is provided between the bolt spring 2 and load and between the nut spring 7 and load than would normally be provided by the use of safety washers. One or both ends of the bolt spring 2 and nut spring 7 can also be flattened as to provide even more contact area. In any embodiments of the present invention, it is possible for the bolt spring 2 to be permanently attached, removably attached, or not at all attached to the bolt head 11. Similarly, it is possible for the nut spring 7 to be permanently attached, removably attached, or not at all attached to the nut 3. Additionally, it is possible for the bolt spring 2 and the nut spring 7 to be used together without the retention spring 4, as shown in FIG. 8.

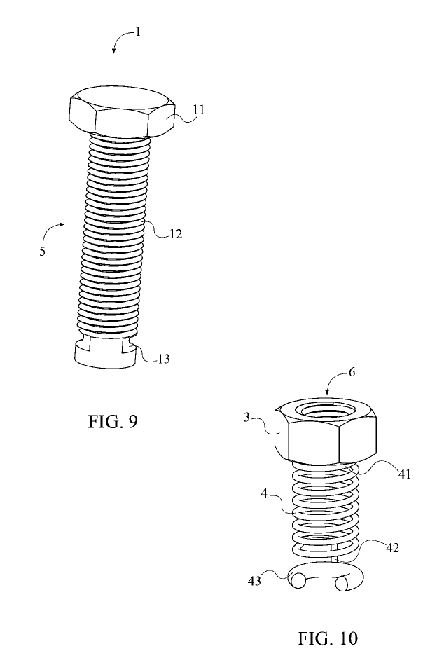

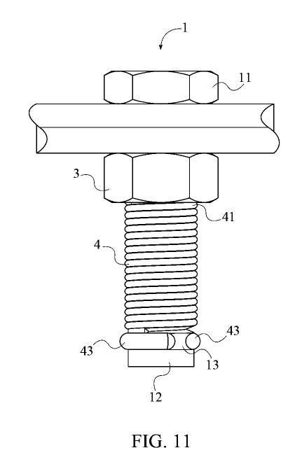

In reference to FIG. 9-11, there exist alternative methods for attaching the retention spring 4 to the bolt shaft 12. In some embodiments of the present invention, the retention spring 4 further comprises a clamp 43. The clamp 43 serves as an alternative connecting mechanism to the straightened second end 42 of the retention spring 4 or the lock pin 8. In a first embodiment, the clamp 43 is a single, U-shaped piece and is constructed from a flexible material. It is also possible for the clamp 43 to be any other shape. The clamp 43 is attached permanently or non-permanently to the second end 42 of the retention spring 4. When a single piece clamp 43 is utilized, the receiving volume 13 encircles the bolt shaft 12, either partially or fully, as opposed to traversing through the bolt shaft 12. The receiving volume 13 is cut to the shape of the clamp 43 and forms a groove around the bolt shaft 12 in which the clamp 43 is positioned. In this way, the clamp 43 can readily be snapped into and out of place within the receiving volume 13. The nut 3 is threaded onto the male threaded portion 5 of the bolt shaft 12 and comes in contact with the load. Once the nut 3 has been positioned, the retention spring 4 is compressed and the clamp 43 is snapped into place within the receiving volume 13 around the end of the bolt shaft 12. Thus, the clamp 43 is fixed in place and in turn the retention spring 4 is fixed in place. The retention spring 4 secures both nut 3 and load independent of the position the nut 3 takes up on the threaded portion of the bolt 1.

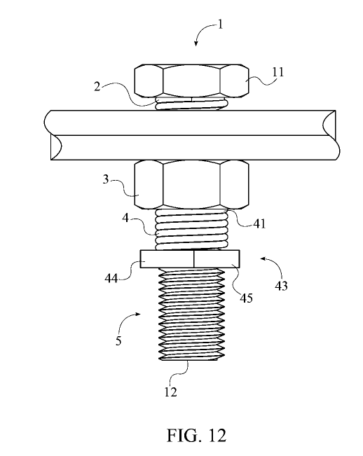

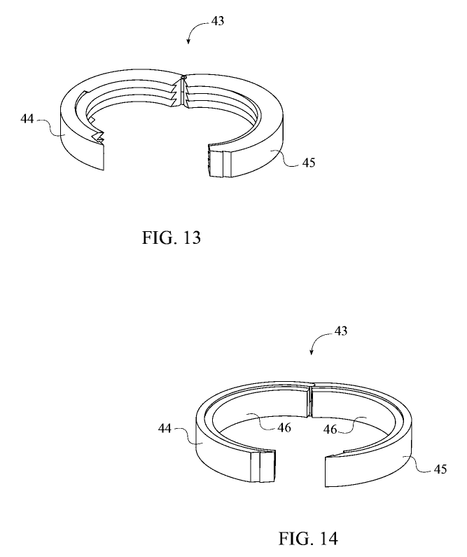

In reference to FIG. 12-13, the clamp 43 may be alternatively designed. In a second embodiment, the clamp 43 comprises a first claw 44 and a second claw 45, the first claw 44 and the second claw 45 being hingedly connected to each other. Similar to the first embodiment of the clamp 43, in the second embodiment, the second end 42 of the retention spring 4 is attached to the first claw 44 and/or the second claw 45 of the clamp 43. The hinged connection allows the first claw 44 and the second claw 45 of the clamp 43 to be opened and closed while remaining attached to one another, such that the clamp 43 can be positioned around the bolt shaft 12. When the clamp 43 is closed, the end of the first claw 44 and the end of the second claw 45 opposite the hinge snap together, locking both halves of the clamp 43 in place. The hinge can be spring loaded as to help retain the closed position of the clamp 43. On the inside surface of both the first claw 44 and second claw 45 there are grooves that are the same or close in depth and width to the threads in the bolt shaft 12. The grooves of the clamp 43 run in a slightly slanted fashion in order to approximate the angle of the male threaded portion 5 of the bolt shaft 12. In the second embodiment, the bolt 1 does not need to feature the receiving volume 13, as the clamp 43 can be positioned around any section of the male threaded portion 5 of the bolt shaft 12.

In reference to FIG. 14, as an alternative to the first claw 44 and the second claw 45 being threaded, the first claw 44 and the second claw 45 each comprise a moldable insert 46. The moldable insert 46 is attached to the inner surface of both the first claw 44 and the second claw 45. The moldable insert 46 of the first claw 44 and the second claw 45 is constructed from a flexible, form-retaining material, such as rubber or foam. When placed around the bolt shaft 12, the moldable insert 46 of the first claw 44 and the second claw 45 conforms to the male threaded portion 5 of the bolt shaft 12. In this way, nearly all of the surface area of the moldable insert 46 is in contact with the bolt shaft 12 which in turn provides a large frictional force to secure the clamp 43 in place. In the second embodiment, the clamp 43 can also be used without the retention spring 4. In this instance the clamp 43 is attached to the bolt shaft 12 directly below the nut 3. It is possible that any number of other connecting/nut stopping mechanisms be used in addition to the mechanisms described above.

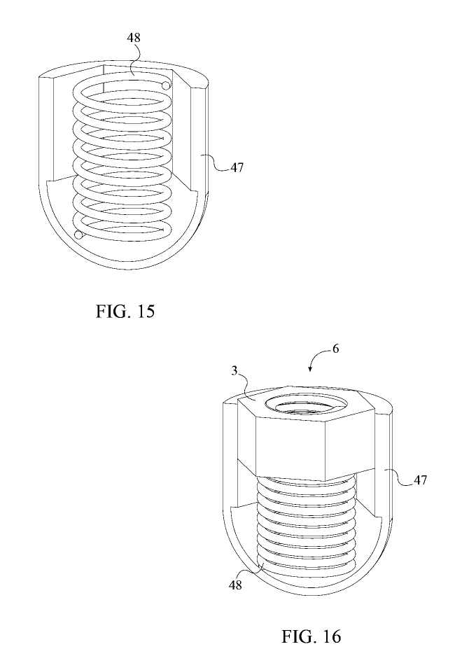

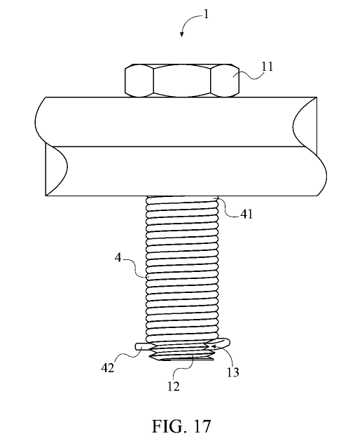

In reference to FIG. 15-16, in an alternative embodiment of the present invention a cap 47 and a cap spring 48 are used to provide balancing torque to the nut 3. The cap spring 48 can be attached permanently or non-permanently to the cap 47. When the cap 47 and cap spring 48 stand alone the cap spring 48 is decompressed. The cap spring 48 is coiled in such a manner that the inner diameter of the coiled cap spring 48 is slightly larger than the outer diameter of the male threaded portion 5. First, the nut 3 is threaded onto the bolt shaft 12 to secure the load. The cap 47 is then fitted over the nut 3 and end of the bolt shaft 12, the bolt shaft 12 traversing through the coiled cap spring 48. In doing so, the cap spring 48 comes in contact with the nut 3 and is compressed inside the cap 47, and in turn the cap spring 48 provides balancing torque to the nut 3. The cap spring 48 secures both nut 3 and load independent of the position the nut 3 takes up on the threaded portion of the bolt 1. The cap 47 also prevents the nut 3 and end of the bolt shaft 12 from being exposed in instances when this is not desired, such as on playgrounds where children could injure themselves on the exposed bolt 1 end. Ideally the cap 47 is made from a rubber or plastic material, however, it is possible that any number of other materials be used.

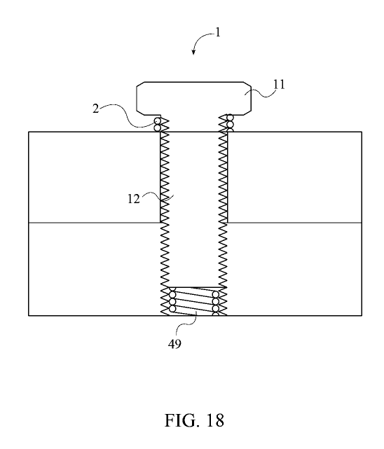

In reference to FIG. 17-18, the self-retaining fastener can also be used in conjunction with a threaded load such as an engine block. Both halves of the load can be threaded as shown in FIG. 13 or only the load furthest from the bolt head 11 can be threaded. In this instance, the threaded load acts as the nut 3 of the self-retaining fastener. The bolt 1 is first threaded through the load. The retention spring 4 is then slipped over the bolt 1 and compressed against the load. The straightened end of the retention spring 4 is then inserted into the receiving volume 13 in the bottom of the bolt 1 as shown in FIG. 17. In this way, the retention spring 4 provides balancing torque to the load such that the bolt 1 will not loosen. The retention spring 4 can also be attached to the bolt 1 using any of the methods described above such as using the clamp 43 of either design. The bolt spring 2 can also be attached between the bolt head 11 and load if desired. This is particularly useful in instances where the end of the bolt 1 is retained within the load as shown in FIG. 18. A load spring 49 can also be used in such instances. The load spring 49 functions in the same way as the cap spring 48 described in the alternative embodiment mentioned above. The load spring 49 rests between the end of the bolt 1 and the load, and can either be attached or unattached to the load. The load spring 49 can also be used internally or externally between load halves (i.e. within or around the hole through which the bolt shaft 12 traverses each half of the load).

Although the invention has been explained in relation to its preferred embodiment, it is to be understood that many other possible modifications and variations can be made without departing from the spirit and scope of the invention as hereinafter claimed.

What is claimed is:

1. A self-retaining fastener comprises:
a nut;
a retention spring;
a male threaded portion;
the nut comprises a female threaded portion;
the female threaded portion being positioned through the nut;
the retention spring being adjacently pressed against the nut; and
the female threaded portion engaging the male threaded portion.

2. The self-retaining fastener as claimed in claim 1 comprises:
the self-retaining fastener further comprises a nut spring; and
the nut spring being adjacently pressed against the nut opposite the retention spring.

3. The self-retaining fastener as claimed in claim 1 comprises:
the self-retaining fastener further comprises a bolt and a bolt spring;
the bolt comprises a bolt head and a bolt shaft;
the bolt shaft being concentrically connected to the bolt head;
the male threaded portion being positioned along the bolt shaft;
the bolt spring being adjacently pressed against the bolt head; and
the bolt spring being coiled around the bolt shaft.

4. The self-retaining fastener as claimed in claim 1 comprises:
the self-retaining fastener further comprises a bolt;
the bolt comprises a bolt head, a bolt shaft, and a receiving volume;
the retention spring comprises a first end and a second end;
the bolt shaft being concentrically connected to the bolt head;
the male threaded portion being positioned along the bolt shaft;
the receiving volume being positioned along the bolt shaft opposite the bolt head;
the receiving volume laterally traversing into the bolt shaft;
the nut being positioned in between the bolt head and the receiving volume;
the first end and the second end being positioned opposite each other along the retention spring;
the first end being pressed against the nut; and
the second end being positioned into the receiving volume.

5. The self-retaining fastener as claimed in claim 1 comprises:
the self-retaining fastener further comprises a bolt and a lock pin;
the bolt comprises a bolt head, a bolt shaft, and a receiving volume;
the retention spring comprises a first end and a second end;
the bolt shaft being concentrically connected to the bolt head;
the male threaded portion being positioned along the bolt shaft;
the receiving volume being positioned along the bolt shaft opposite the bolt head;
the receiving volume laterally traversing into the bolt shaft;
the lock pin being positioned into the receiving volume;
the nut being positioned in between the bolt head and the receiving volume;
the first end and the second end being positioned opposite each other along the retention spring;
the first end being pressed against the nut; and
the second end being positioned into the lock pin.

6. The self-retaining fastener as claimed in claim 1 comprises:
the self-retaining fastener further comprises a bolt;
the bolt comprises a bolt head, a bolt shaft, and a receiving volume;
the retention spring comprises a first end, a second end, and a clamp;
the bolt shaft being concentrically connected to the bolt head;
the male threaded portion being positioned along the bolt shaft;
the receiving volume being positioned along the bolt shaft opposite the bolt head;
the receiving volume encircling the bolt shaft;
the receiving volume traversing into the bolt shaft;
the nut being positioned in between the bolt head and the receiving volume;
the first end and the second end being positioned opposite each other along the retention spring;
the first end being pressed against the nut;
the clamp being attached to the second end; and
the clamp being positioned into the receiving volume.

7. A self-retaining fastener comprises:
a bolt;
a bolt spring;
a female threaded portion;
the bolt comprises a bolt head, a bolt shaft, and a male threaded portion;
the bolt shaft being concentrically connected to the bolt head;
the male threaded portion being positioned along the bolt shaft;
the bolt spring being adjacently pressed against the bolt head;
the bolt spring being coiled around the bolt shaft; and
the male threaded portion engaging the female threaded portion.

8. The self-retaining fastener as claimed in claim 7 comprises:
the self-retaining fastener further comprises a nut and a nut spring;
the female threaded portion being positioned through the nut;
the nut spring being adjacently pressed against the nut; and
the nut spring being coiled around the bolt shaft.

9. The self-retaining fastener as claimed in claim 7 comprises:
the self-retaining fastener further comprises a nut, a retention spring, and a nut spring;
the female threaded portion being positioned through the nut;
the retention spring being adjacently pressed against the nut;
the nut spring being adjacently pressed against the nut opposite the retention spring; and
the retention spring and the nut spring being coiled around the bolt shaft.

10. The self-retaining fastener as claimed in claim 7 comprises:
the self-retaining fastener further comprises a nut and a retention spring;
the retention spring comprises a first end and a second end;
the bolt further comprises a receiving volume;
the female threaded portion being positioned through the nut;
the receiving volume being positioned along the bolt shaft opposite the bolt head;
the receiving volume traversing into the bolt shaft;
the nut being positioned in between the bolt head and the receiving volume;
the first end and the second end being positioned opposite each other along the retention spring;
the first end being pressed against the nut; and
the second end being positioned into the receiving volume.

11. The self-retaining fastener as claimed in claim 7 comprises:
the self-retaining fastener further comprises a nut, a retention spring, and a lock pin;
the retention spring comprises a first end and a second end;
the bolt further comprises a receiving volume;
the female threaded portion being positioned through the nut;
the receiving volume being positioned along the bolt shaft opposite the bolt head;
the receiving volume traversing into the bolt shaft;
the lock pin being positioned into the receiving volume;
the nut being positioned in between the bolt head and the receiving volume;
the first end and the second end being positioned opposite each other along the retention spring;
the first end being pressed against the nut; and
the second end being positioned into the lock pin.

12. The self-retaining fastener as claimed in claim 7 comprises:
the self-retaining fastener further comprises a nut and a retention spring;
the retention spring comprises a first end, a second end, and a clamp;
the bolt further comprises a receiving volume;
the female threaded portion being positioned through the nut;
the receiving volume being positioned along the bolt shaft opposite the bolt head;
the receiving volume encircling the bolt shaft;
the receiving volume traversing into the bolt shaft;
the nut being positioned in between the bolt head and the receiving volume;
the first end and the second end being positioned opposite each other along the retention spring;
the first end being pressed against the nut;
the clamp being attached to the second end; and
the clamp being positioned into the receiving volume.

13. A self-retaining fastener comprises:
a bolt;
a bolt spring;
a nut;
a retention spring;
the bolt comprises a bolt head, a bolt shaft, and a male threaded portion;
the nut comprises a female threaded portion;
the bolt shaft being concentrically connected to the bolt head;
the male threaded portion being positioned along the bolt shaft;
the bolt spring being adjacently pressed against the bolt head;
the bolt spring being coiled around the bolt shaft;
the female threaded portion being positioned through the nut;
the retention spring being adjacently pressed against the nut;
the retention spring being coiled around the bolt shaft; and
the male threaded portion engaging the female threaded portion.

14. The self-retaining fastener as claimed in claim 13 comprises:
the bolt further comprises a receiving volume;
the retention spring comprises a first end and a second end;
the receiving volume being positioned along the bolt shaft opposite the bolt head;
the receiving volume laterally traversing into the bolt shaft;
the nut being positioned in between the bolt head and the receiving volume;
the first end and the second end being positioned opposite each other along the retention spring;
the first end being pressed against the nut; and
the second end being positioned into the receiving volume.

15. The self-retaining fastener as claimed in claim 13 comprises:
the self-retaining fastener further comprises a lock pin;
the bolt further comprises a receiving volume;
the retention spring comprises a first end and a second end;
the receiving volume being positioned along the bolt shaft opposite the bolt head;
the receiving volume laterally traversing into the bolt shaft;
the lock pin being positioned into the receiving volume;
the nut being positioned in between the bolt head and the receiving volume;
the first end and the second end being positioned opposite each other along the retention spring;
the first end being pressed against the nut; and
the second end being positioned into the lock pin.

16. The self-retaining fastener as claimed in claim 13 comprises:
the bolt further comprises a receiving volume;
the retention spring comprises a first end, a second end, and a clamp;
the receiving volume being positioned along the bolt shaft opposite the bolt head;
the receiving volume encircling the bolt shaft;
the receiving volume traversing into the bolt shaft;
the nut being positioned in between the bolt head and the receiving volume;
the first end and the second end being positioned opposite each other along the retention spring;
the first end being pressed against the nut;
the clamp being attached to the second end; and
the clamp being positioned into the receiving volume.

17. The self-retaining fastener as claimed in claim 13 comprises:
the self-retaining fastener comprises a nut spring;
the nut spring being adjacently pressed against the nut opposite the retention spring; and
the nut spring being coiled around the bolt shaft.

18. The self-retaining fastener as claimed in claim 13 comprises:
the retention spring comprises a first end, a second end, and a clamp;
the clamp comprises a first claw and a second claw;
the first claw being hingedly connected to the second claw;
the first end and the second end being positioned opposite each other along the retention spring;
the first end being pressed against the nut;
the clamp being connected to the second end; and
the clamp encircling the bolt shaft.

19. The self retaining bolt as claimed in claim 18 comprises:
the first claw and the second claw being threaded; and
the first claw and the second claw engaging the male threaded portion.

20. The self-retaining fastener as claimed in claim 18 comprises:
the first claw and the second each comprise a moldable insert; and
the first claw and the second claw engaging the male threaded portion.
